(19) United States
(12) Patent Application Publication
(10) Pub. No.: US 2009/0055777 A1
(43) Pub. Date: Feb. 26, 2009

(54) Method for Interactive Display of Shortcut Keys

(76) Inventor: Tobias Kiesewetter, Dachau (DE)

Correspondence Address: IP STRATEGIES, 12 1/2 WALL STREET, SUITE E, ASHEVILLE, NC, 28801, US

(21) Appl. No.: 11/841,415

(22) Filed: Aug. 20, 2007

(51) Int. Cl. G06F 3/048

(52) U.S. Cl. 715/847

(57) ABSTRACT

Computer-implemented method and apparatus for displaying keyboard keys on a screen of a computer system, comprising the following steps: displaying graphical icons at predefined positions on a screen; each of the graphical icons representing a command to be executed by the computer system when mouse-clicked; monitoring whether a predefined first key is pressed on a keyboard; and when the predefined first key is pressed, toggling the displayed graphical icons to display predefined second keys at the positions of the graphical icons, each of the second keys forming with the predefined first key a shortcut key for the command represented by the graphical icon.

### FIELD OF THE INVENTION

The present invention relates in general to the field of data entry and display interfaces, such as keyboards, computer screens and the like, and more particularly to a method for interactive display of shortcut keys to easily retrieve assigned shortcut keys on a computer system or on other digital electronic processing devices.

### BACKGROUND OF THE INVENTION

Computer shortcut keys also named shortkeys or hotkeys are commands entered by the user via a keyboard to permit quick execution of tasks. Known examples are “Ctrl+C” for “copy” or “Ctrl+V” for “paste” of data. In most cases the shortcut key is given by a combination of a special key (like “Shift”, “Alt” or “Ctrl”, the Microsoft-key, or the Apple-key) along with another non-special key of the keyboard. Such special keys, which are pushed and held while other keys are pushed, are sometimes denoted as modal function keys.

By selection of a menu item the respective shortcut keys are sometimes presented in the corresponding menu list displayed on the screen. In most cases the user needs to retrieve shortcut key combinations with the support of the help system or by using the help manual of an application.

In general, the productivity of a user increases by the use of shortkeys. It is faster and more ergonomic to keep using the keyboard instead of constantly changing focus between mouse and keyboard.

Shortkeys that are not used very frequently fall into oblivion. The user manuals of applications are time consuming to read and not always up to date or complete with regard to referencing the right short-keys. To date, there is no intuitive way of retrieving assigned shortcut keys.

Most of the tasks that the user can execute by a shortcut key combination are also accessible by use selecting a menu item or by the use of a toolbar button on a screen.

In view of the above, it would be desirable to have a data entry interface which could be better used with shortcut keys.

### SUMMARY OF THE INVENTION

In accordance with these and other objects, there is provided a new and improved method and system to help the user to interactively find the corresponding shortcut key of a toolbar or palette bitmap.

In general, in one aspect, this invention provides methods and apparatus, including computer program products, for displaying keyboard keys on a screen of a computer system, comprising the following steps:
a. displaying graphical icons at predefined positions on a screen; each of the graphical icons representing a command to be executed by the computer system when mouse-clicked;
b. monitoring whether a predefined first key is pressed on a keyboard; and
c. when the predefined first key is pressed, toggling the displayed graphical icons to display predefined second keys at the positions of the graphical icons, each of the second keys forming with the predefined first key a shortcut key for the command represented by the graphical icon.

Advantageous implementations can include one or more of the following features.

The inventive method may further comprise a step of:
d. when the predefined first key and one of the predefined second keys are together pressed, executing the command according to the shortcut key formed by the predefined first key and second key.

The inventive method may further comprise a step of:
d. when the predefined first key, a predefined third key, and one of the predefined second keys are together pressed, executing the command of the shortcut key of the pressed predefined first key, second key, and third key.

The predefined positions may be located within a toolbar element on the screen, or within a palette element on the screen.

Toggling the displayed graphical icons may be performed such that the predefined second keys are displayed instead of the respective graphical icons.

As an alternative, toggling the displayed graphical icons may be performed such that the predefined second keys are displayed together with the respective graphical icons.

As a further alternative, toggling the displayed graphical icons may be performed such that the predefined second keys are displayed in front of the respective graphical icons, the respective graphical icons being displayed in the background.

The predefined first key may be one of CTRL key, Shift key, ALT key, Microsoft-key, Apple-key and Function key of the keyboard.

The combinations of the predefined first key and second key may be shortkeys.

The second keys may be character keys of the keyboard.

The displayed graphical icons to display the predefined second keys may be performed if a second key is pressed in combination with the first key.

Toggling the displayed predefined second keys back to the graphical icon display may be performed if the first key is released.

Toggling the displayed predefined second keys back to the graphical icon display may be performed if the second key is pressed.

In case the user already knows a shortkey combination, an immediate toggling of the icons may bear the disadvantage of a flickering effect (as soon as the special key is pressed, the icons toggle to show the corresponding second key and toggles back again). To prevent this nervous flickering or flashing of the toolbar icons it is helpful to implement a short delay (e.g. one tenths of a second) prior to toggling to the shortkey display.

In particular, the invention comprises also computer systems for performing the inventive methods.

Furthermore, the invention comprises computer-readable storage media comprising program code for performing the inventive methods, when loaded into a computer system.

One of the advantages is that the present invention provides quick access to shortkeys.

Various other purposes and advantages of the invention will become clear from its description in the specification that follows. Therefore, to the accomplishment of the objectives described above, this invention includes the features hereinafter fully described in the detailed description of the preferred embodiments, and particularly pointed out in the claims. However, such description discloses only some of the various ways in which the invention may be practiced.

### BRIEF DESCRIPTION OF THE DRAWINGS

In the following, non-limiting embodiments of the present invention are described with reference to the drawings wherein:

FIG. 1A, B illustrate a program window with an application tool bar including graphical icons before and after toggling of the display;

FIG. 2A, B illustrate the application tool bar before and after toggling in more detail;

FIG. 3 illustrates a flowchart diagram of an exemplary embodiment of the present invention; and

FIGS. 4A, B illustrate a further embodiment of the invention.

### DETAILED DESCRIPTION OF THE INVENTION

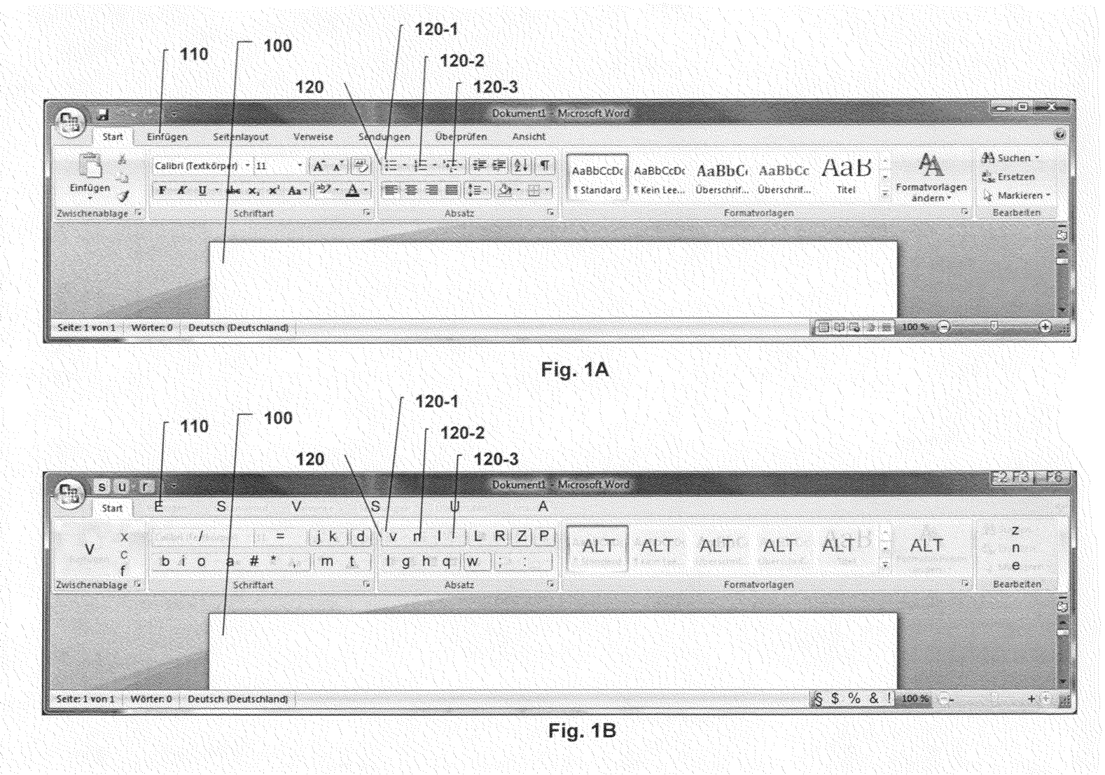

Referring to the figures, FIG. 1A illustrates a usual program window displayed on a computer screen. The program window, in this case, is an editor of a word processor. As usual, the window is divided in several portions. Portion 100 represents the text field in which the typed characters are displayed. On top of the window displayed is a menu bar 110 where commands are arranged in menus to be activated or executed via mouse-click. Further, there is a toolbar 120 with icons 120-1, 120-2, 120-3 arranged which allow direct activation or execution by mouse-click on the respective icons 120-1, 120-2, 120-3. Usually, the icons are coded as bitmaps. The commands can be selected (i.e., executed) by mouse-click on the respective icon.

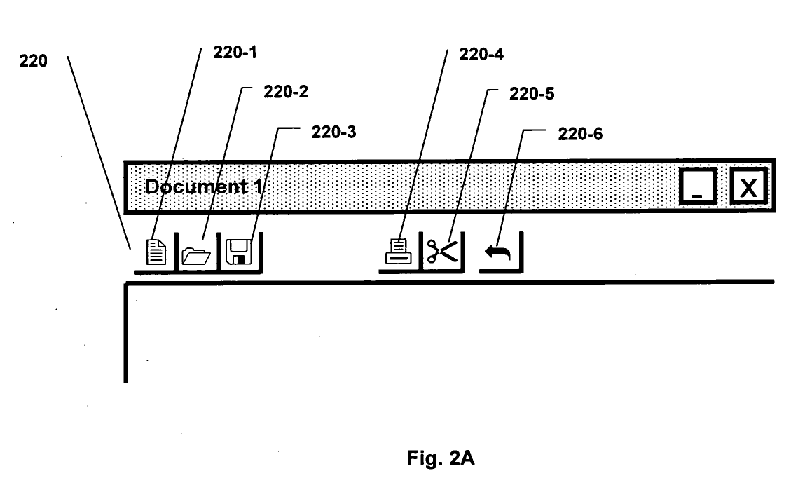

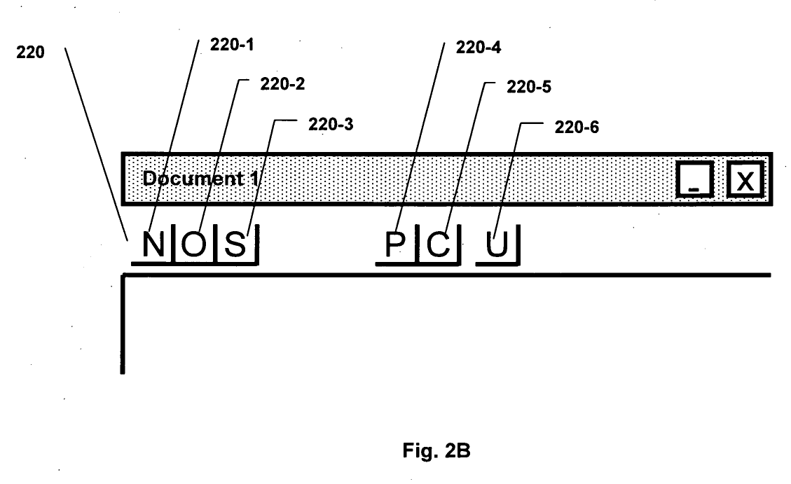

FIG. 1B illustrates the window of FIG. 1A after toggling, i.e., upon special key stroke, as will be described in connection with FIG. 2A, B in more detail.

FIG. 2A, B illustrate schematically the part of the window of FIG. 1 which relates to the toolbar 120 before and after toggling In this illustrative embodiment, icon 220-1 represents an “Open new document” functionality, icon 220-2 represents “Open file”, icon 220-3 represents “Save document to disc”, icon 220-4 represents “Print document”, icon 220-5 represents Cut”, and 220-6 represents “Undo”.

According to the invention, by pressing a special key on the keyboard, the bitmaps of the toolbar 220 toggle to display the corresponding second keystroke for execution of the respective command. FIG. 2B illustrates an example of the optical support to retrieve a shortcut. In that example, the icon 220-1 of the toolbar of FIG. 2A displays opening a new document. Let us assume the corresponding shortcut is “Ctrl+N”. If the user presses the Ctrl-button, the toolbar bitmap toggles to display an “N” instead of the graphical icon 220-1, as shown in FIG. 2B. The user then enters the second key to execute the respective command. The toolbar toggles back to display the graphical icons. In the same way, the other icons of the toolbar are toggled to display the respective second keystroke. Thus, icon 220-2 is toggled to display “O”, icon 220-3 is toggled to display “S”, and so on.

The method is independent of the allocation of the shortcuts. If in the above example the shortcut for the task “Open new document” is allocated to e.g. the second keystroke “R”, an “R” is shown instead of an “N”. The same shortkey combination could also be allocated to two different icons, provided however that those icons are not accessible at the same time. This provides the option of double allocations of shortkeys in one and the same application e.g. if the toolbar icon is changing in different modes of the application.

In most cases the toolbar is a special module of a larger application program. This module has access to resources like the graphical icons. To give a toolbar a more interactive design the icons changes if e.g. the mouse pointer is moving across the icon or if the icon is pressed. Also the icon is often shadowed in case the respective task is inactive.

To implement the described innovation the toolbar module also keeps track of the use of special keys. A resource is provided to map the graphical icons to the respective shortcut keys. This mapping resource may also be changed dynamically in case e.g. the user allocates own shortcut preferences. In case a shortcut listed in the mapping resource is pressed, the application is mapping the respective icon of the second keystroke and displays this icon instead of the graphical icon. The icons for display of the second keystroke may either be pre-designed or may be dynamically build by the use of the letter resources of the computer system.

The current invention is supplementing the current practice by a method to also provide for interactive shortkey access.

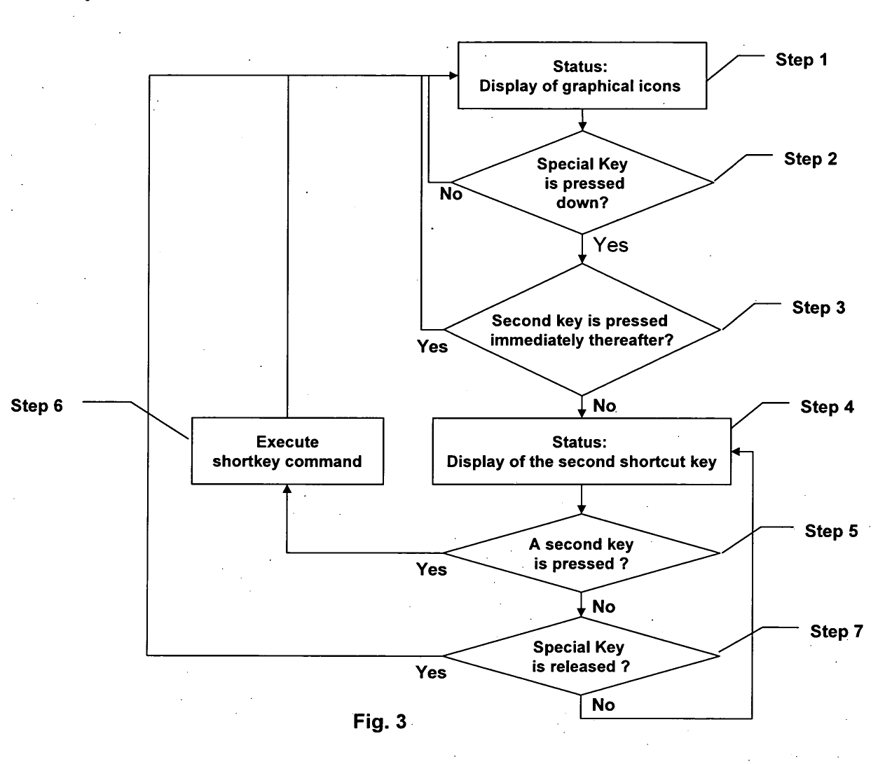

FIG. 3 provides a flowchart diagram of an exemplary embodiment of the invention. Per default the graphical icons are shown on a screen in a toolbar or palette (Step 1). This may be called a first status or “normal mode”. After pressing a special key (e.g., the “CTRL” key on the keyboard (Step 2), a short delay (Step 3) prevents a flickering effect for the case that the user wants to execute a known shortkey command. If the user has not been executed such command, the toolbar icons toggle to display the corresponding second keystrokes for executing the respective shortcuts of the tasks shown in the toolbar (Step 4). If the second key is now pressed by the user (Step 5), the so-defined shortkey command will be executed by the computer system (Step 6), and the toolbar toggles back to the normal mode to display the graphical icons (Step 1). If not, the shortcut key icons are displayed until the user either releases the special key (Step 7) or executes a shortcut command.

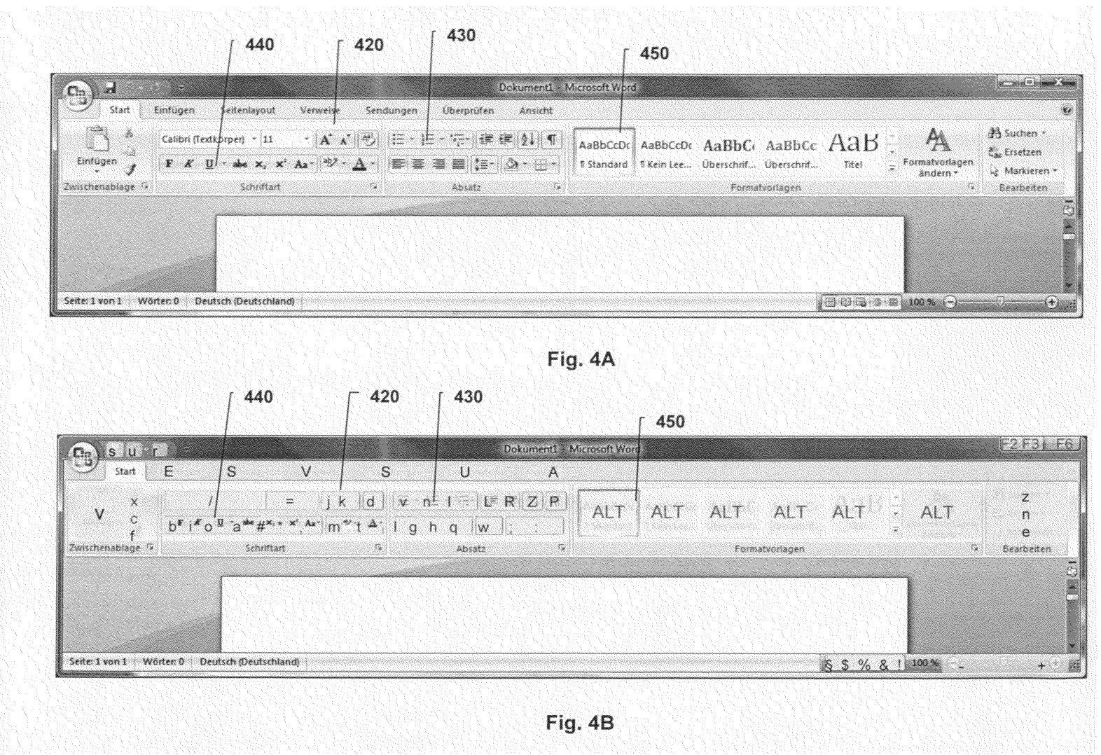

A further embodiment of the invention is illustrated in connection with FIGS. 4A, B. This embodiment deals with the situation that there are several sets of short-key commands 420, 430, 440, 450 which require different special keys to be pressed. That is, a first set of shortkey commands 420, 430, 440 may be executed with the “CTRL” key being pressed together with a predetermined second key, while a second set of shortkey commands 450 may be executed with the “ALT” key being pressed. Then, the toggling is performed as follows. Upon pressure of one of the special keys, the set of graphical icons 420, 430, 440 which are to be executed with the pressed first key are toggled to display the respective second key (as before) while the set of graphical icons 450 representing commands which to be executed by with a special keys other than the pressed key are toggled to display that special key. The display of that latter special key may be somewhat faded in order to indicate that that special key is currently not pressed. In FIG. 4A, the first set 420, 430, 440 of shortkey commands, which is executed with the pressed “CTRL” key, is toggled to display the respective second key, see FIG. 4B. Shortkey commands 420 are toggled as described with reference to FIGS. 1 and 2. The second set of shortkey commands 450, which is executed with the “ALT” key, is toggled to display “ALT”, see again FIG. 4B.

In a further embodiment of the invention, the display is toggled in a slightly different way. Instead of toggling the display of the graphical representation of the command (i.e., the icon) to displaying the second key only (as illustrated at reference numeral 420), the second key may be displayed together with the graphical icon. Then, the graphical icon may be “in the background”, as illustrated at reference numeral 430.

Further, the graphical icon may be displayed side by side with the respective second key, as illustrated at reference numeral 440.

The present invention disclosed herein may be implemented as a method, apparatus or article of manufacture using standard programming or engineering techniques to produce software, firmware, hardware, or combinations thereof.

I claim:

1. A computer-implemented method for displaying keyboard keys on a screen of a computer system, comprising the following steps:
a. displaying graphical icons at predefined positions on a screen; each of the graphical icons representing a command to be executed by the computer system when mouse-clicked;
b. monitoring whether a predefined first key is pressed on a keyboard; and
c. when the predefined first key is pressed, toggling the displayed graphical icons to display predefined second keys at the positions of the graphical icons, each of the second keys forming with the predefined first key a shortcut key for the command represented by the graphical icon.

2. The method of claim 1, further comprising a step:
d. when the predefined first key and one of the predefined second keys are together pressed, executing the command according to the shortcut key formed by the predefined first key and second key.

3. The method of claim 1, further comprising a step:
d. when the predefined first key, a predefined third key, and one of the predefined second keys are together pressed, executing the command of the shortcut key of the pressed predefined first key, second key, and third key.

4. The method of claim 1, wherein the predefined positions are located within a toolbar element on the screen.

5. The method of claim 1, wherein the predefined positions are located within a palette element on the screen.

6. The method of claim 1, wherein toggling the displayed graphical icons is performed such that the predefined second keys are displayed instead of the respective graphical icons.

7. The method of claim 1, wherein toggling the displayed graphical icons is performed such that the predefined second keys are displayed together with the respective graphical icons.

8. The method of claim 1, wherein toggling the displayed graphical icons is performed such that the predefined second keys are displayed in front of the respective graphical icons, the respective graphical icons being displayed in the background.

9. The method of claim 1, wherein the predefined first key is one of CTRL key, Shift key, ALT key, Microsoft-key, Apple-key and Function key of the keyboard.

10. The method of claim 1, wherein the combinations of the predefined first key and second key are shortkeys.

11. The method of claim 1, wherein toggling the displayed graphical icons to display is performed a predefined time after the first key is pressed.

12. The method of claim 1, wherein the second keys are character keys of the keyboard.

13. The method of claim 1, wherein toggling the displayed graphical icons to display the predefined second keys is performed if a second key is pressed in combination with the first key.

14. The method of claim 1, wherein toggling the displayed predefined second keys back to the graphical icon display is performed if the first key is released.

15. The method of claim 1, wherein toggling the displayed predefined second keys back to the graphical icon display is performed if the second key is pressed.

16. An apparatus for displaying keyboard keys on a screen, adapted to perform the steps of:
a. displaying graphical icons at predefined positions on a screen; each of the graphical icons representing a command to be executed by the computer system when mouse-clicked;
b. monitoring whether a predefined first key is pressed on a keyboard; and
c. when the predefined first key is pressed, toggling the displayed graphical icons to display predefined second keys at the positions of the graphical icons, each of the second keys forming with the predefined first key a shortcut key for the command represented by the graphical icon.

17. The apparatus of claim 16, further adapted to perform a step of:
d. when the predefined first key and one of the predefined second keys are together pressed, executing the command according to the shortcut key formed by the predefined first key and second key.

18. The apparatus of claim 16, further adapted to perform a step of:
d. when the predefined first key, a predefined third key, and one of the predefined second keys are together pressed, executing the command of the shortcut key of the pressed predefined first key, second key, and third key.

19. The apparatus of claim 16, wherein the predefined positions are located within a toolbar element on the screen.

20. The apparatus of claim 16, wherein the predefined positions are located within a palette element on the screen.

21. The apparatus of claim 16, wherein toggling the displayed graphical icons is performed such that the predefined second keys are displayed instead of the respective graphical icons.

22. The apparatus of claim 16, wherein toggling the displayed graphical icons is performed such that the predefined second keys are displayed together with the respective graphical icons.

23. The apparatus of claim 16, wherein toggling the displayed graphical icons is performed such that the predefined second keys are displayed in front of the respective graphical icons, the respective graphical icons being displayed in the background.

24. The apparatus of claim 16, wherein the predefined first key is one of CTRL key, Shift key, ALT key, Microsoft-key, Apple-key and Function key of the keyboard.

25. The apparatus of claim 16, wherein the combinations of the predefined first key and second key are shortkeys.

26. The apparatus of claim 16, wherein toggling the displayed graphical icons to display is performed a predefined time after the first key is pressed.

27. The apparatus of claim 16, wherein the second keys are character keys of the keyboard.

28. The apparatus of claim 16, wherein toggling the displayed graphical icons to display the predefined second keys is performed if a second key is pressed in combination with the first key.

29. The apparatus of claim 16, wherein toggling the displayed predefined second keys back to the graphical icon display is performed if the first key is released.

30. The apparatus of claim 16, wherein toggling the displayed predefined second keys back to the graphical icon display is performed if the second key is pressed.

31. A computer-readable medium having computer-executable instructions for displaying keyboard keys on a screen of a computer system, comprising the steps of:
a. displaying graphical icons at predefined positions on a screen; each of the graphical icons representing a command to be executed by the computer system when mouse-clicked;
b. monitoring whether a predefined first key is pressed on a keyboard; and
c. when the predefined first key is pressed, toggling the displayed graphical icons to display predefined second keys at the positions of the graphical icons, each of the second keys forming with the predefined first key a shortcut key for the command represented by the graphical icon.
